(19) United States
(12) Patent Application Publication
(10) Pub. No.: US 2011/0180564 A1
(43) Pub. Date: Jul. 28, 2011

(54) Timing Soap Dispenser Apparatus and Method

(76) Inventors: Terry G. Jones, Austin, TX (US); John Morris Lynn, Austin, TX (US)

(21) Appl. No.: 13/014,981

(22) Filed: Jan. 27, 2011

Related U.S. Application Data
(60) Provisional application No. 61/336,831, filed on Jan. 27, 2010.

(51) Int. Cl. B67D 7/00; B67D 7/22; B67D 7/08; B67D 7/86; B23P 19/04; B67D 7/84

(52) U.S. Cl. 222/1; 222/39; 222/23; 222/25; 29/428; 222/113; 222/638; 222/192

(57) ABSTRACT

A soap dispenser system for dispensing soap in response to a user's action, such as pumping force to a dispenser pump of a soap container. The soap container has a theme identifier device corresponding to the soap container. A supportive base detachably connects to the soap container. The base includes a receiver device for detecting the theme identifier device of the soap container when the soap connector is connected to the base. A readable data storage is connected to the receiver device. The storage contains data representing a variety of different human perceptible media, such as audio (e.g., animal, people, or musical sounds). At least one of the variety of media corresponds to the theme identifier device of the soap container. An output device delivers the media to a user of the soap container. A processor connected to the receiver device, the storage, and the output device responds to the receiver detecting the theme identifier device and dispensing action by a user to obtain soap from the container. The processor selectively controls the output device to deliver specific media (from among the variety) to the user corresponding to the theme identifier device of the soap container. The system can encourage frequent and efficacious washing. The media encourages washing for recommended wash times, for example, the system delivers 20-30 seconds (or such other period as desired for the particular embodiment) of animal sounds for entertainment and measure of recommended wash time when an animal themed soap container is used.

### CROSS-REFERENCE TO RELATED APPLICATION

The present application is a conversion of and has benefit of priority of the following application, which is co-pending and has at least one same inventor of the present application: U.S. Provisional Patent Application No. 61/336,831, titled “Timing soap dispenser base apparatus”, filed Jan. 27, 2010.

### TECHNICAL FIELD

The present invention is related to hand hygiene and is more particularly related to a soap dispenser base apparatus that helps time hand washing duration and encourages more frequent hand washing.

### BACKGROUND

In a variety of different fields, businesses and residences, there is a great desire that people wash their hands more effectively and more frequently. The US Center for Disease Control has stated that “The most important thing you can do to keep from getting sick is to wash your hands”. And yet, many people, through lack of knowledge, poor habits or simple negligence either do not wash their hands frequently enough or effectively enough.

One of the keys to effective hand washing is the duration of the time one should wash their hands. For many years, parents have instructed their children to time their hand washing by singing songs that last roughly 20-30 seconds (the desired hand washing period) as they wash their hands. A popular example of an attempt to get a child to time their hand washing is singing the “Happy Birthday Song” twice while washing.

Others (e.g., U.S. Pat. No. 5,771,925) have attempted to take the guesswork out of timing for 20 seconds by including a timing mechanism as part of the soap dispenser apparatus itself. Also, others have attempted to notify a user of the soap of the desired wash duration by providing soap that changes color after some period of time as the soap is being lathered up (example, Inspector Hector™ soap from ViJon Corporation). Other schemes have supplied a marker on a soap dispenser in a manner that tags a mark on the user's hand which requires 20 seconds or so of lathering to wash off (e.g., SquidSoap™ from SquidSoap LP). The attempts described above to help a user know how long to wash their hands all require that each individual soap dispenser have some type of timing, marking or a soap with color changing capability. This requirement that each and every soap dispenser have special timing capabilities can raise the cost of the soap dispenser.

To help address the problems, another approach provided a timing mechanism in a base product that allowed multiple different soap dispensers to be used on the same timing base (U.S. Pat. No. 7,315,245 and hereinafter the '245 patent). The '245 patent allows for soap dispensers (i.e. bottles) that do not have timing mechanisms and this allows for less expensive soap dispensers than ones which have timing features included on each bottle. The '245 patent provides significant improvements to encourage hand washing.

It would be advantageous to further entice use of a soap dispenser for hand washing. Enticing hand washing through use of a soap dispenser (especially for children) is an excellent way to get users to wash more often and to wash more thoroughly and effectively. More frequent washing in conjunction with improved hand washing duration can result in dramatically improved hand washing efficacy. Therefore, it would be a significant improvement to provide a cost effective, multi-use soap dispenser that entices use of the soap dispenser for frequent washing and effective washing duration.

### SUMMARY

An embodiment of the invention is a soap dispenser system including a soap container with a pump dispenser. The system includes a base for attaching and supporting in attachment the soap container and the pump dispenser, in combination, and a circuit of the base capable of outputting a plurality of different audible signals. The soap bottle includes attachment means intended to be detachably attached in use to said base, and when attached to the base, communicates with the base and the base selectively outputs one of the plurality of different audible signals corresponding to the soap bottle.

Another embodiment of the invention is a soap dispenser system including a base with lights and a soap bottle with attachment means capable of detachably connecting to the base. The lights of the base selectively illuminate only when dispensing force is applied to the soap bottle.

Yet another embodiment of the invention is a soap dispenser system including a soap dispenser base capable of delivering a plurality of different audible signals, lights communicatively connected to the base, and a soap bottle containing soap, the soap bottle includes attachment means capable of detachably connecting to the base. The soap bottle, when connected to the base, is detected by the base via the attachment means. The base selectively delivers one of the different audible signals corresponding to the soap bottle upon, in use, dispensing soap from the soap bottle.

Another embodiment of the invention is a soap dispenser system for dispensing soap in response to an action including a soap container having a theme identifier device corresponding to the soap container, a supportive base detachably connected to the soap container, a receiver device connected to the supportive base, for detecting the theme identifier device of the soap container when the soap connector is connected to the base, a storage connected to the receiver device, the storage containing data representing a plurality of different human perceptible media, at least one of the plurality corresponds to the theme identifier device of the soap container, an output device for delivering the plurality of different human perceptible media, and a processor connected to the receiver device, the storage, and the output device, the processor, responsive to the receiver detecting the theme identifier device and the action for dispensing the soap, selectively accesses and processes data of the storage representing the at least one of the plurality corresponding to the theme identifier device of the soap container, and controls the output device to deliver the at least one of the different human perceptible media corresponding to the theme identifier device of the soap container.

Yet another embodiment of the invention is a method of manufacture of a soap dispenser system for a soap user. The soap container has a thematic device and dispenses soap in response to an action of the user. The method includes providing a base for the soap container, providing a thematic detector for the base, the thematic detector capable of discerning the thematic device of the soap container when the soap container contacts the base, connecting a controller to the thematic detector, and connecting a device for human perceptible output to the controller, the device controlled by the controller to output a human perceptible media corresponding to the thematic device of the soap container.

Another embodiment of the invention is a method of manufacture of a media player base for a soap dispenser container. The soap dispenser container includes a type identifier. The method includes providing a circuit to control an output media corresponding to the type identifier, connecting a detector of the type identifier to the circuit, connecting a sensor to the circuit, and housing the circuit, the detector, and the sensor as a unit. The circuit controls the output media corresponding to the type identifier, responsive to the detector based on the type identifier and to the sensor when soap is dispensed by the soap dispenser container.

Yet another embodiment of the invention is a method of manufacture of a media player base for a plurality of different soap dispenser containers. Each of the plurality of soap dispenser containers includes a unique type identifier. The method includes providing a circuit to control a plurality of unique output media, each respective one of the plurality of unique output media corresponds to a respective one of the unique type identifier, connecting a detector to the circuit, the detector uniquely identifies each respective one of the unique type identifier for the circuit, connecting a sensor to the circuit, the sensor detects for the circuit when soap is dispensed from one of the plurality of soap dispenser containers then uniquely identified by the detector, and housing the circuit, the detector, and the sensor as a unit. The circuit controls delivery of the unique output media corresponding to the unique type identifier for the one of the plurality of soap dispenser containers, responsive to the detector based on the unique type identifier and to the sensor when soap is dispensed by the soap dispenser container.

Another embodiment of the invention is a method of washing. The method includes placing a soap dispenser container having a type identifier on a media player base, detecting by the media player base the type identifier, detecting by the media player base that soap is dispensed from the soap dispenser container, and outputting by the media player base a select human perceptible media in response to the step of detecting the type identifier and detecting that soap is dispensed, the select human perceptible media corresponds to the type identifier.

### BRIEF DESCRIPTION OF THE DRAWINGS

The present invention is illustrated by way of example and not limitation in the accompanying figures, in which like references indicate similar elements, and in which:

FIG. 1 illustrates a cross section of a soap dispenser base with a male attachment for mating with a bottle of soap, according to certain embodiments of the invention;

FIG. 2 illustrates a cross section of a bottle of soap with a female attachment suitable for mating with the male attachment of the soap dispenser base of FIG. 1, according to certain embodiments of the invention;

FIG. 3 illustrates a top down view of the base of FIG. 1 showing a non-symmetrical shape of the male attachment and lights on a surface of the base, according to certain embodiments of the invention;

FIG. 4 illustrates a block functional schematic of an exemplary control system for controlling audible sound and visual light elements of the base of FIG. 1, according to certain embodiments of the invention;

FIG. 5 illustrates a flow diagram of a process of an exemplary operation of the base of FIG. 1 in use during hand washing, according to certain embodiments of the invention;

FIG. 6 illustrates a system of a media player base for a soap dispenser bottle, according to certain embodiments of the invention; and

FIG. 7 illustrates a high level functional unit representation of a controller of the media player base of FIG. 6, according to certain embodiments of the invention.

### DETAILED DESCRIPTION

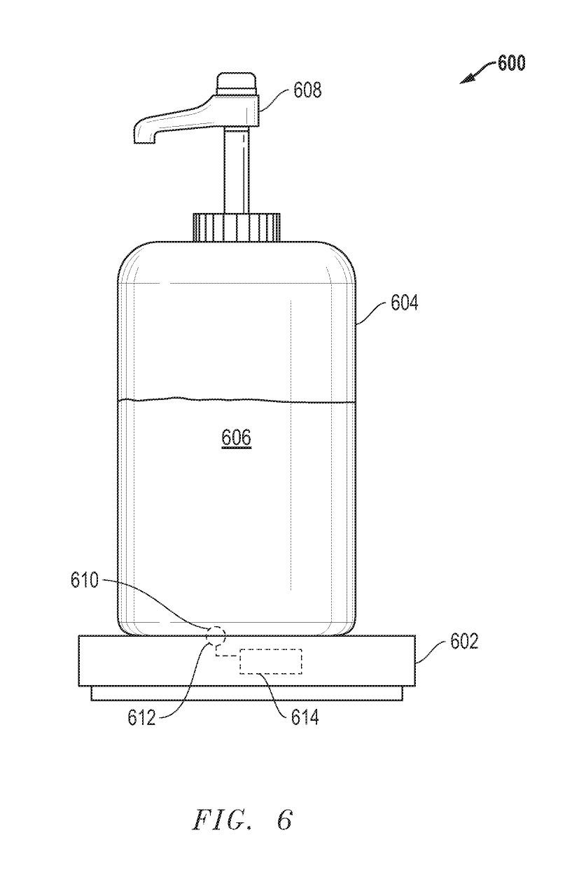

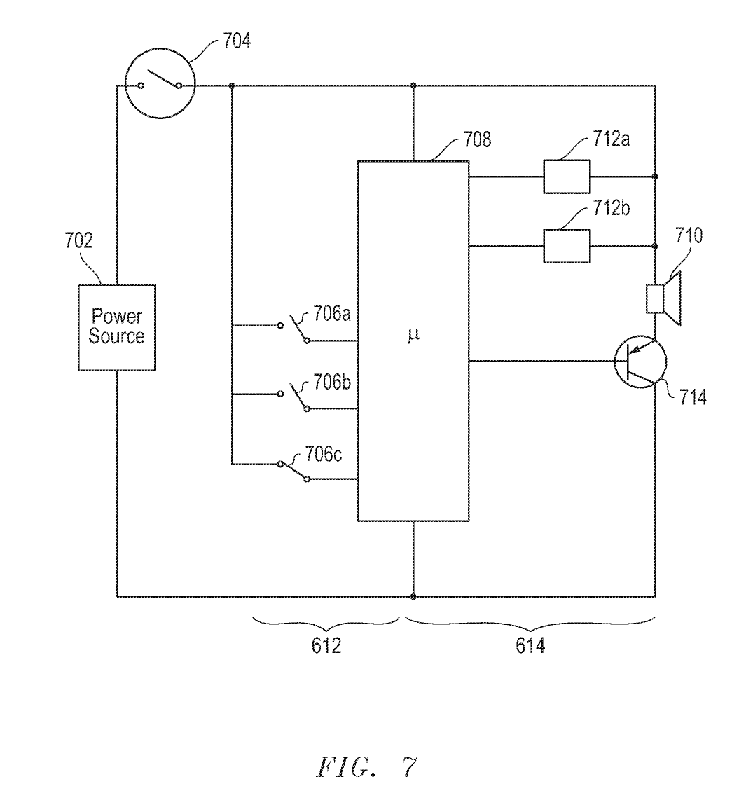

Referring to FIG. 6, a system 600 includes a media player base 602 and a soap dispenser bottle 604 (shown in phantom). The soap dispenser bottle 604 is interchangeable, and may be replaced with other soap dispenser bottles. The media player base 602, however, is reusable for various dispenser bottles. For example, soap dispenser bottles are often consumables that are replaced when soap contents are depleted. The base 602, therefore, is usable with replacements of the soap dispenser bottle 604 as will be further discussed.

The soap dispenser bottle 604 contains soap 606 and includes a dispenser pump 608 of the type which may be pressed with downward (in FIG. 6) force to dispense the soap 606. The dispenser bottle 604 includes an identifier device 610. The identifier device 610 is included as part of the bottle 604 and is detectable by the base 602 when the bottle 604 is located sitting atop the base 602. The identifier device 610 is unique to the particular type of the bottle 604, and the correspondence of the identifier device 610 with particular type of the bottle 604 will be later further addressed.

Continuing to refer to FIG. 6, the base 602 provides a stable support under the bottle 604 when the bottle 604 sits on the base 602. The base may sit on a countertop, sink surface, or other generally horizontally disposed plane (not shown in FIG. 6), and the bottle 604 is located atop the base 602 in use. The base 602 includes a detector device 612 (shown in phantom) for discerning the identifier device 610 of the bottle 604 when the bottle 604 is placed atop the base 602. The base 602 also includes a media player device 614 (shown in phantom) connected to the detector device 612.

In operation, the base 602 is located on a support surface and the bottle 604 is placed on the base 602. When the bottle 604 is placed on the base 602, the detector device 612 of the base 602 discerns the identifier device 610 of the bottle 604. The media player device 614 of the base 602, in response to the discerned identifier device 610 of the bottle 604, commences operations selective to the identifier device 610 and, thus, the particular type of the bottle. The identifier device 610, because corresponding to the particular type of the bottle 604, allows the media player device 614 to selectively operate for the bottle 604, and its particular type.

According to certain embodiments, for example, the bottle 604 can have a type that corresponds to a particular scheme or theme, such as that of a particular animal, event, person or other thing recognizable to a person who will wash with the soap 606 dispensed from the bottle 604. In the case of a particular scheme or theme for any bottle, the bottle may include particular visible decorative indicia or emblem, shape of the bottle, color of the bottle or soap, and/or others. As a more specific exemplary possibility (among a wide variety of alternatives) for type of the bottle, the bottle may be dinosaur themed. Such dinosaur themed bottle may contain green soap and a decorative emblem of a dinosaur on the bottle. Because the identifier device 610 of the bottle 604 corresponds to the type and thus theme of the particular bottle, the detector device 612 of the base 602 can discern the identifier device 610 and then operate in accordance with the type and theme of the particular bottle.

The media player device 614 of the base 602, for example, includes or communicatively accesses data representing audible sounds, such as animal sounds which may include the sound of a dinosaur. The media player device 614 accesses particular data, and thus a particular sound is produced, corresponding to the identifier device 610 discerned by the detector device 612. According to certain embodiments, the media player device 614 includes (not shown in FIG. 6) a processor, data storage or memory, and sound output device connected to a power source.

When any particular type of the bottle 604 contacts the base 602, such that the identifier device 610 of the bottle 604 indicative of particular bottle type is discerned by the detector device 612 of the base 602, the media player device 614 of the base 602 commences operating responsive to the particular identifier device (and therefore particular bottle type). When any different particular type of the bottle 604 (with different identifier device) instead contacts the base 602 (and the detector device 612 discerns the different identifier device), the media player device 614 of the base 602 commences differently operating in response to the different identifier device and therefore different particular type of the bottle 604.

Referring to FIG. 7, although FIG. 7 shows a particular illustration, the illustration is intended and should be understood merely as a higher level functional block or unit representation of functional elements of a controller 700 of the base. Therefore, each specific element of the controller 700 should be understood as a functional unit or block in nature, and not necessarily as any particular electronic component or apparatus even if illustrated as such for purpose of explanation.

Continuing to refer to FIG. 7, in conjunction with FIG. 6, the controller 700 of the media player base 602 comprises the detector device 612 and the media player device 614. A power source 702 is connected to a first switch 704. The first switch 704 remains open unless and until closed by dispensing the soap 606 from the bottle 604 for washing, for example, the first switch 704 closes (and connects the power source in closed circuit in the controller 700) only when a pumping force is made on the dispenser pump 608 of the bottle 604 to dispense soap 606 when the bottle 604 sits on the base 602.

As an alternative to a pumping force used to close the first switch 704, it is possible to utilize a touch free soap dispenser system to trigger output of audible sound or other human perceptible media by the base or other configuration of components in similar to those of the system. One example of such a touch free dispenser system with the ability to utilize multiple refill bottles is the Lysol™ No-Touch Hand Soap system.

The first switch 704 is connected to three identification switches 706a, 706b and 706c. Each of the identification switches 706a, 706b, 706c connects to a processor (or logic circuit) 708. The identification switches 706a, 706b, 706c in combination with the processor 708 are an example of the detector device 612. In the example, a particular type of the bottle 604 may have an identifier device 610 that closes identification switch 706c, but not identification switches 706a or 706b. Per the example, the closed identification switch 706c instigates particular processing by the processor 708 corresponding to the particular identifier device 610 of the bottle 604 (and consequently the particular type of the bottle). A different bottle might, for example, have a different identifier device that closes identification switch 706a, but not identification switches 706b or 706c. In such instance, the processor 708 accordingly processes differently to correspond to the different identifier device (and thus different type of the bottle).

The processor 708 is connected to one or more human detectable output devices, for example, a speaker 710 and/or one or more lights 712a, 712b, such as LED or other lights. The output devices, for example the speaker 710 and lights 712a, 712b, or some or all of these devices, are connected to an output switch 714 connected to or included in the processor 708. The output switch 714 is controlled by the processor 708 for on and off operation of the output devices, or certain of them, and may additionally provide rectification, amplification or other function.

The processor 708 includes or accesses one or more timing device and memory or other data storage (not shown in detail in FIG. 7). Data representing one or more audible sounds and/or other human perceptible media is stored in the memory/storage. The memory/storage also holds data representing one or more control logic sets for control of timing and output from the output devices.

In operation, when the switch 704 closes in response to a user dispensing the soap 606 from the bottle 604 via the pump 608, the identifier device 610 of the particular type of the bottle 604 then in contact with the base 602 triggers one of the identification switches 706a, 706b or 706c closed. The processor 708 discerns which of the identification switches 706a, 706b or 706c thereby is closed, and commences processing data representing about a 20 to 30 second period of audible sound for output by the speaker 710. Additionally, the processor 708 may process data representing state of the lights 712a, 712b for on or off control during the 20-30 second period of audible sound or otherwise. In effect, the processor 708 controls output of the speaker 710 and lights 712a, 712b providing about 20-30 seconds of audio sound and lighting after soap is dispensed. Alternately, time periods for output may be longer, shorter or otherwise. In other alternatives, sound may be output only after 20 seconds (or some other desired period) whereas lights may be powered on for the 20 seconds (or other period) prior to the sound output. Of course, numerous variations are possible in these outputs and control by the processor 708, in view of the type of the bottle and identifier device and the capability of the base to detect the bottle type thereby and deliver human perceptible output as provided by the base. Also, because different bottles (with different identifier device) may have different themes, output by the base can be coordinated with the particular theme for each particular different bottle.

As described in connection with FIGS. 6-7, the identifier device 610, the detector device 612, and the functional unit representation of the controller 700 provide generalities of embodiments. Certain examples according to the foregoing general embodiments follow:

### Examples

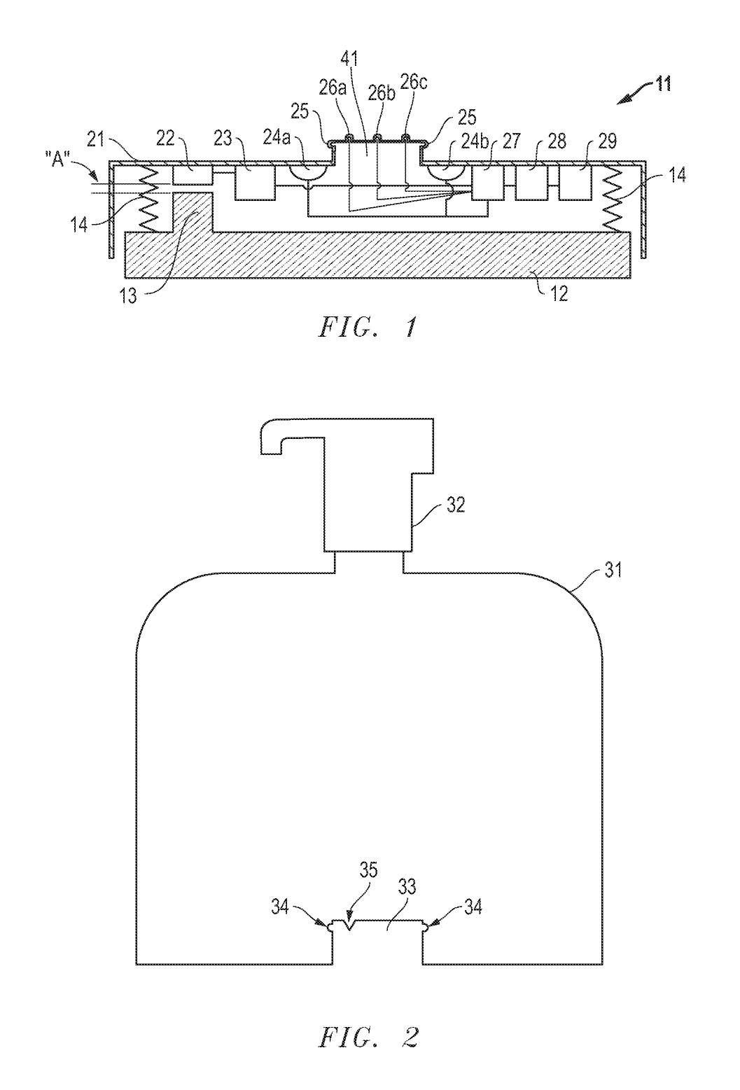

Referring to FIG. 1, a soap dispenser base 11 comprises two major sections. A lower section 12 is designed to sit on a surface where one might find a soap dispenser (e.g. a counter top). An upper section 21 is capable of attaching to and sitting on top of the lower section 12 such that the lower section 12 and the upper section 21 fit together to form the base 11. The upper section 21 is attached to the lower section 12 by sliding engagement in such manner that the upper section 21 is capable of moving up and down (over a small gap extent “A”) in relation to the lower section 12 in attachment thereto. A biasing device 14 keeps the upper section 21 in a normally raised position in sliding engagement vis-à-vis the lower section 12, such that the gap extent “A” exists between portions of the upper section 21 and the lower section 12. The biasing device 14 can be any of a large number of well known biasing mechanisms or components such as, for example, springs, foam, elastomers, O-rings and/or others.

Referring to FIG. 2, in conjunction with FIG. 1, a soap dispenser bottle 31 is capable of being detachably attached to the upper section 21 of the base 11. As a pump 32 on the bottle 31 is depressed to get liquid soap from the bottle 31, the pumping action on the dispenser bottle 31 applies downward pressure force on the upper section 21 of the base 11. Further, the downward pressure force on the upper section 21 puts pressure on the biasing device 14 which in turn overcomes the upward bias and moves the upper section 21 downward relative to the lower section 12, to close the small gap extent “A” (closed gap extent not shown in FIG. 1) when the base 11 with bottle 31 is positioned stationary on a counter top or other surface or the like.

The lower section 12 includes an appendage 13. The appendage 13 is raised above the upper surface (in the illustration of FIG. 2) of the lower section 12. Further the bottom surface (in the illustration of FIG. 2) of the upper section 21 may include a switch mechanism 22 that is directly above the appendage 13 when the upper section 21 is connected in sliding engagement with the lower section 12. The appendage 13 and the switch 22 are placed and sized such that the appendage 13 does not touch the switch 22 because of the gap extent “A” maintained by the biasing device 14 when the bias is not overcome by sufficient downward pressure force applied to the upper section 21 to overcome the upward bias of the bias device 14. The bias device 14 sufficiently biases the upper section 21 slidingly extended upward in attachment with the lower section 12 maintaining the gap extent “A” between the appendage 13 and the switch 22 when the soap bottle 31 sits in connection atop the base 11 full of soap (but without downward force for dispensing soap asserted on the pump 32 of the bottle 31). The upward bias of the upper section 21 vis-à-vis the lower section 12 maintains the switch 22 above and not in contact with the appendage 13. However, the upward biasing from the bias device 14 is overcome when a downward pumping action is made by a user on the pump 32 to dispense soap. This downward pumping action exerts downward pressure force against the bottle 31 and consequently against the upper section 21, thereby forcing the upper section 21 to slide downward in attachment to the lower section 12 to close the gap extent “A” and contact the switch 22 to the appendage 13.

In certain alternatives, the appendage 13 is not necessary if the switch 22 extends downward (in the illustration of FIG. 2) far enough below the other portions and components of the upper section 21 to allow the switch 22, but not other functional portions of the upper section 21 (as later described), to contact the lower section 12 when the upper section 21 slides downward against the bias closing the gap to the lower section 12.

A standard soap bottle typically may weigh about 2 lbs or less and the amount of pressure force needed to activate a typical soap dispenser pump is on the order of about 5-7 pounds of pressure force. This difference between the weight of a full soap bottle and the pressure needed to pump soap allows for a large variety of biasing approaches and mechanisms. In certain alternatives, the separate biasing device 14 may not be necessary, for example, the upper section 21 can be made of a flexible material that flexes down when downward pressure is exerted on it but then flexes back when the pressure is removed.

Referring to FIG. 4, in conjunction with FIG. 1, a control system 40 of the base 11, such as, for example, an electronic circuit of electrical elements and connections, may be included in the upper section 21 (or, although not shown in FIGS. 1 and 4, may otherwise be communicatively connected to the upper section 21). The control system 40 includes the switch 22. The switch 22 can be any of a large number of different types of switches such as contact switches, micro-electro-mechanical switches, pushbutton, toggle, slide, as well as other switches. The switch 22 is operative to switch “on” (close the circuit 40) when the switch 22 contacts the appendage 13 and to switch “off” (opening or shorting the circuit 40) when the switch 22 is not in contact with the appendage 13 for some period of time, such as, for example, from after about 20-30 seconds after contact is made to switch “on” or other time period as desired in the embodiment. Timing for switching by the switch 22 can be controlled by the processor 27 or another timer (not shown in FIG. 4) of the system 40, and alternately the switch 22 can comprise mechanical timed switching or other timing for switching as will be understood by those skilled in the art. In the embodiments, the switch 22, for example, operates to switch “on” power by closing the circuit of the system 40 when the switch 22 contacts the appendage 13 and the switch 22 thereafter remains “on” (closed circuit) for a desired period after the contact, such as for about 20-30 seconds.

The switch 22 is communicatively connected to a power source 23 and a processor 27. The power source 23 may be a battery (e.g. a nine volt standard battery or other battery) or another electrical source such as a direct or alternating current power supply, and the system 40 may include transducer, regulator, and/or other components as may be desired for powering the processor 27 and other components of the system 40. The processor 27 is communicatively connected to a speaker/transducer 28, a memory component 29 and one or more bottle identification button 26a, 26b and 26c. The speaker/transducer 28 is capable of outputting an audible sound, for example, an animal sound or music, responsive to the processor 27 and power from the power source 23. The memory component 29, which may be included in the processor 27 or communicatively connected to the processor 27, stores data representing one or more of the audible sounds for selective output by the speaker/transducer 28 under control of the processor 27. The one or more bottle identification button 26a, 26b, 26c each provide a switch or flag input to the processor 27 for controlling processing operations of the processor 27.

Referring to FIG. 5, a method 50 is performed by the base 11 when the bottle 31 is attached and downward pumping force is applied to the pump 32 for dispensing soap. In a step 51, the switch 22 is triggered to “on” closing the circuit connecting the power source 23 to the processor 27. In a step 52, the processor 27 then commences processing for controlling the speaker/transducer 28 and the memory component 29, in response to state of the button 26a-c. In a step 53, the processor 27 detects which, if any, of the bottle identification buttons 26a, 26b or 26c have been pushed (i.e., depressed, selected or otherwise activated by attachment of the bottle 31). In response to the step 53, the processor 27 in a step 54 (accesses from the memory 29, if necessary, and) processes data representing applicable media for output by the speaker/transducer 28. The particular data processed in the step 54 represents particular media selected according to state of the button 26a-c detected in the step 53. For example, in certain embodiments, the processor 27 in the step 54 processes data representing a song for delivery to the speaker/transducer 28 and, in a step 55, the processor 27 controls the speaker/transducer 28 to output for about 20 to 30 seconds an audible sound of the song. In alternative embodiments, the processor 27 in the step 54 processes data representing the song for delivery to the speaker/transducer 28, however, the processor 27 in the step 55 controls the speaker/transducer 28 to only output the audible sound of the song after about 20-30 seconds has passed from commencement of the step 51.

Referring back to FIGS. 1-3, in conjunction with FIGS. 4 and 5, the identification buttons are automatically pushed (only one a time) when the bottle 31 is placed on the base 11 by aligning a male attachment 41 of the upper section 21 of the base 11 with a female attachment 33 on the underside of the bottle 31. The male attachment 41 can snap into the female attachment 33, such as, for example, via a lip 25 on the male attachment 41 and a corresponding channel 34 on the female attachment 33 (this snapping mechanism can be reversed such that the lip is part of the female attachment means). A wide variety of mechanisms and components are possible for detachably attaching the bottle 31 to the base 11 as will be apparent to those skilled in the art.

When the bottle 31 is placed on the base 11 with the male attachment 41 inserted into and snapped onto the female attachment 33, a bottle appendage 35 protruding from the female attachment 33 is located such that, as an example (as illustrated in FIGS. 1 and 2), the appendage 35 pushes the button 26a. When the base 11 is activated by someone pushing downward the pump 32 of the soap bottle 31, the processor 27 detects that button 26a has been depressed and signals the speaker/transducer 28 to produce audible sound at the end of 20 seconds (or other desired period) from the time that the switch 22 first contacts the appendage 13, for example, producing the sound of a dinosaur roaring after 20 seconds (or other period).

When another type of soap bottle is placed on base 11 (e.g., a pony themed soap bottle rather than a dinosaur themed bottle), the appendage 35 is located in a different position (not shown in detail in FIG. 2) relative to the male attachment 41 of the base 11. This different position of the appendage 35 causes the appendage 35 to push, for example, bottle identification button 26b when downward force is applied to the pump 32 of the soap bottle 31. In this case of a differently themed bottle of soap (with different male attachment 41 position) on the base 11, the processor 27, when operative because of contact of the switch 22 with the appendage 13, detects that bottle identification button 26b is depressed. In response to detecting depression of the button 26b, the processor 27 directs the transducer/speaker 28 to make a different audible sound after 20 seconds (or other desired period in the embodiment), for example, an audible neigh sound of a pony. In various alternatives, the processor 27 can have respective data file(s) representing the various audible sounds stored in the processor itself (such as in memory component or other storage of the processor 27), or the respective data file(s) representing the audible sounds may be stored on the memory component 29, another storage communicatively connected to the processor for such sounds, or otherwise. The memory component 29 in certain alternatives may also be controlled by the processor 27 to program record(s) of usage of the base 11, to provide feedback, such as by audible output of the speaker/transducer 28 or output report, about hand washing usage and trends, and to allow loading of additional data file(s) representative of sounds, alternative functions, or other features, or attachment of additional or ancillary components or elements, for example, visible clock, error reporter, soap level indicator, visual display, and/or others.

In certain embodiments of the invention, audible feedback from speaker/transducer 28 may provide not only entertainment but may teach. For example, when triggered, the speaker/transducer 28 in certain embodiments is controlled by the processor 27 to play the ABC song (from data representing the song stored in memory, other storage, or otherwise generated) for the entire 20 seconds (or other desired period) of hand washing and, once 20 seconds (or other period) has passed, stops play of the song. This teaching capability may be of great interest to parents trying to educate children. In another example, a Spanish themed soap dispenser may trigger a base that aids a child to learn Spanish as they wash their hands, for example, through play for about 20 to 30 seconds of a Spanish tutorial for children output by the speaker/transducer 28 as controlled by the processor 27. In other examples, the base 11 could include in memory various data files representing different educational information that cycles through as the base triggers the processor 27 to control output of the speaker/transducer 28 in response to depression of the soap dispenser. This could also be used by adults, in order to learn new languages, or skills. As can be understood, a wide variety of content can be stored as data files in memory and processed by the processor 27 as output of the speaker/transducer 28 or other device or display.

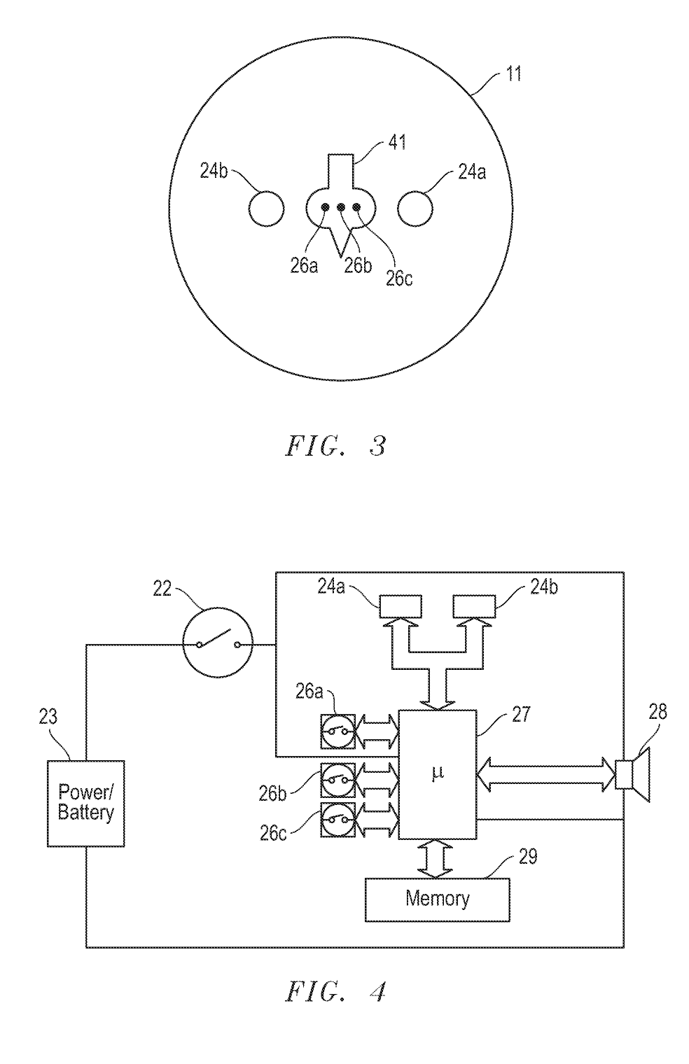

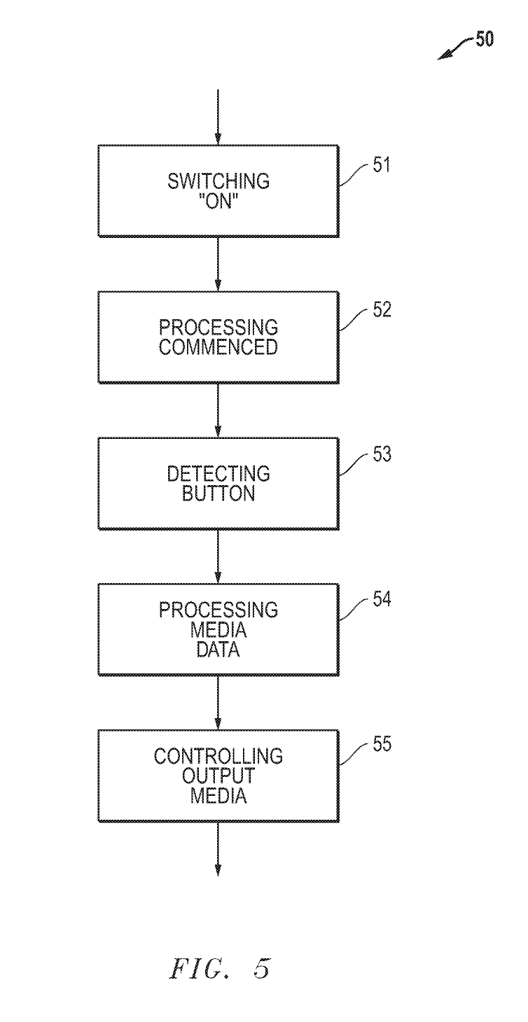

In order to assure that appendage 35 on bottle 31 is oriented correctly vis-à-vis the bottle identification buttons 26a, 26b and 26c, the male attachment 41 and the female attachment 33 in certain embodiments are each shaped in a non-symmetrical manner, so that the bottle 31 must be selectively oriented for placement on the base 11 for attaching the male attachment 41 and the female attachment 33. Referring to FIG. 3 for an example of non-symmetrical shapes, the base 11 includes an irregularly shaped male attachment 41. A corresponding female attachment 33 on the bottle 31 must be similarly shaped for attaching the bottle 31 with the base 11. This assures that the bottle 31 is selectively oriented in location in connection to the base 11. This further assures that the appendage 35 (shown in FIG. 2) can properly depress a select bottle identification button 26a, 26b, or 26c that is intended for the particular bottle 31 (i.e., this assures that the base 11 provides the applicable audible noise when triggered for the particular bottle 31, such as, for example, when the bottle 31 has particular theme and a corresponding sound for that theme applies).

In addition to triggering audible timing prompts as discussed above, in certain embodiments of the invention, the processor 27 communicatively connects to lights 24a and 24b, for example. These lights 24a, 24b can be positioned for external viewing in the top of the base 11 and directed into the bottle 31 when positioned on the base 11. The lights 24a and 24b in certain embodiments are controlled by the processor 27 to emit on when the pump 32 is pressingly pumped, and then to turn emission off 20-30 seconds later. This allows a hand washing user to know that the base 11 is working properly. It also can result in some entertaining or interesting visual effects in the soap itself in certain embodiments. It is not necessary that the lights be pointed up into the soap, however; in some embodiments lights are included in a side of the base 11. Such arrangement of lights, for example, provides user information about operability of the base 11, such as that the base 11 is active for operation when the lights are on. In other embodiments, lights can provide additional signal(s) of hand washing timing, such as could be especially useful for those unable to discern audible sounds or for aiding stimulation of the user through other features of the base 11. In certain alternatives, a top surface of the base 11 is transparent and lights 24a and 24b are not on the top surface of base 11 but instead are located underneath the transparent surface of the base 11.

Although the base 11 and its operation during hand washing have been described, the base 11 can alternatively be provided with similar or additional elements, components or connectors for other wash or dispensing situations. For example, the base 11, if incorporated with or communicatively connected to appropriate output devices, can provide a wide variety of output from the base initiated upon dispensing action. For example, other visual, audio, video, media or report outputs can be delivered from the base, either to components incorporated in the base or to external communicatively connected components. In certain alternatives, additional switch or control mechanisms may be included in the base or otherwise in embodiments, for example, a switch may be included to allow selective turn “off” of sound output or other features (such a mechanism may be desirable to parents, in particular, in embodiments for use by children). In other alternatives, the base and the soap bottle or other soap vessel may be contained within an enclosure or be connected by attachment mechanisms that prevent unauthorized disengagement of the base and bottle or vessel. Such base and soap bottle or vessel combination may be targeted for washing by restaurant employees or others in food, drug, medical, or other environment where non-contamination, cleanliness, and effective washing is important. Because sounds, lights, and other output of the base can be varied for an applicable target audience of washing users, a communication port or other device can be included in the base for varying operations and output. For example, soap of the dispenser having suspended air bubbles can be illuminated via lights of the embodiments, providing dramatic lighting effects in the soap as the light bounces off of the bubble interfaces. All variations of designs, configurations, output elements, shapes, circuits, and devices therefor, as may be applicable for target use, target user and environment of use, are within the scope of the foregoing.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and device(s), connection(s) and element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A soap dispenser system including a soap container with a pump dispenser, comprising:
a base for attaching and supporting in attachment the soap container and the pump dispenser, in combination;
a circuit of the base capable of outputting a plurality of different audible signals;
wherein the soap bottle includes attachment means intended to be detachably attached in use to said base;
wherein the soap bottle, when attached to the base, communicates with the base and the base selectively outputs one of the plurality of different audible signals corresponding to the soap bottle.

2. A soap dispenser system, comprising:
a soap dispenser base having lights; and
a soap bottle with attachment means capable of detachably connecting to the base;
wherein the lights of the base selectively illuminate only when dispensing force is applied to the soap bottle.

3. A soap dispenser system, comprising:
a soap dispenser base capable of delivering a plurality of different audible signals;
lights communicatively connected to the base; and
a soap bottle containing soap, the soap bottle includes attachment means capable of detachably connecting to the base;
wherein the soap bottle, when connected to the base, is detected by the base via the attachment means;
wherein the base selectively delivers one of the plurality of different audible signals corresponding to the soap bottle upon, in use, dispensing soap from the soap bottle.

4. A soap dispenser system for dispensing soap in response to an action, comprising:
a soap container having a theme identifier device corresponding to the soap container;
a supportive base detachably connected to the soap container;
a receiver device connected to the supportive base, for detecting the theme identifier device of the soap container when the soap connector is connected to the base;
a storage connected to the receiver device, the storage containing data representing a plurality of different human perceptible media, at least one of the plurality corresponding to the theme identifier device of the soap container;
an output device for delivering the plurality of different human perceptible media;
a processor connected to the receiver device, the storage, and the output device, the processor, responsive to the receiver detecting the theme identifier device and the action for dispensing the soap, selectively accesses and processes data of the storage representing the at least one of the plurality corresponding to the theme identifier device of the soap container, and controls the output device to deliver the at least one of the different human perceptible media corresponding to the theme identifier device of the soap container.

5. The soap dispenser system of claim 4,
wherein the output device is at least one illuminator;
wherein each of the plurality of human perceptible media is at least one visible light of the at least one illuminator.

6. The soap dispenser system of claim 4,
wherein the output device is at least one speaker;
wherein each of the plurality of human perceptible media is at least one audible sound of the at least one speaker.

7. The soap dispenser system of claim 4,
wherein the output device is at least one speaker and at least one illuminator, in combination;
wherein each of the plurality of human perceptible media is at least one sound of the at least one speaker and at least one visible light of the at least one illuminator.

8. The soap dispenser system of claim 4, further comprising:
a timer for controlling the processor, the processor controls the output device to deliver the at least one of the different human perceptible media corresponding to the theme identifier device of the soap container for about 20 to about 30 seconds upon the action for dispensing the soap.

9. The soap dispenser system of claim 4, further comprising:
a timer for controlling the processor, the processor controls the output device to deliver the at least one of the different human perceptible media corresponding to the theme identifier device of the soap container upon about 20 to about 30 seconds after the action for dispensing the soap.

10. The soap dispenser system of claim 4, further comprising:
a detector of the base connected to the processor, for determining occurrence of the action for dispensing the soap;
wherein the action for dispensing the soap is a force applied to the base via the soap container in excess of a weight of the soap container when filled with the soap.

11. A method of manufacture of a soap dispenser system for a soap user of a soap container has a thematic device, the soap container dispenses soap in response to an action of the user, comprising the steps of:
providing a base for the soap container;
providing a thematic detector for the base, the thematic detector capable of discerning the thematic device of the soap container when the soap container contacts the base;
connecting a controller to the thematic detector;
connecting a device for human perceptible output to the controller, the device controlled by the controller to output a human perceptible media corresponding to the thematic device of the soap container.

12. The method of claim 11, further comprising the steps of:
providing a plurality of different ones of the thematic device;
wherein the thematic detector of the base is capable of discerning each different one of the thematic device as unique;
wherein the controller is capable of controlling the device for human perceptible output to deliver a respective unique human perceptive media corresponding to each respective different one of the thematic device.

13. The method of claim 11, further comprising the steps of:
providing connecting a sensor to the base, the sensor can detect if any of the soap is dispensed from the soap container;
connecting the sensor to the controller, the controller directs output from the device for human perceptible output in response to the sensor if any of the soap is dispensed from the soap container.

14. A method of manufacture of a media player base for a soap dispenser container, the soap dispenser container includes a type identifier, comprising the steps of:
providing a circuit to control an output media corresponding to the type identifier;
connecting a detector of the type identifier to the circuit;
connecting a sensor to the circuit; and
housing the circuit, the detector, and the sensor as a unit;
wherein the circuit controls the output media corresponding to the type identifier, responsive to the detector based on the type identifier and to the sensor when soap is dispensed by the soap dispenser container.

15. A method of manufacture of a media player base for a plurality of different soap dispenser containers, each of the plurality of soap dispenser containers includes a unique type identifier, comprising the steps of:
providing a circuit to control a plurality of unique output media, each respective one of the plurality of unique output media corresponds to a respective one of the unique type identifier;
connecting a detector to the circuit, the detector uniquely identifies each respective one of the unique type identifier for the circuit;
connecting a sensor to the circuit, the sensor detects for the circuit when soap is dispensed from one of the plurality of soap dispenser containers then uniquely identified by the detector; and
housing the circuit, the detector, and the sensor as a unit;
wherein the circuit controls delivery of the unique output media corresponding to the unique type identifier for the one of the plurality of soap dispenser containers, responsive to the detector based on the unique type identifier and to the sensor when soap is dispensed by the soap dispenser container.

16. A method of washing, comprising the steps of:
placing a soap dispenser container having a type identifier on a media player base;
detecting by the media player base the type identifier;
detecting by the media player base that soap is dispensed from the soap dispenser container;
outputting by the media player base a select human perceptible media in response to the step of detecting the type identifier and detecting that soap is dispensed, the select human perceptible media corresponds to the type identifier.

17. The method of claim 16, wherein the soap dispenser container is selected from a plurality of differently themed containers and each differently themed container of the plurality has a respective type identifier, the soap dispenser container then in use for the media player base has the respective type identifier for a respective one of the differently themed container;
wherein the step of detecting by the media player base the type identifier detects the respective type identifier for the respective one of the soap dispenser container;
whereas the step of outputting by the media player base outputs one respective human perceptible media from among a plurality of respective human perceptible media, each respective one of the plurality corresponds to one of the respective type identifier for one of the differently themed container, and the step of media player base varies output according to the respective human perceptible media for the respective type identifier of the one of the differently themed container then in use with the base.
